(19) United States
(12) Patent Application Publication
(10) Pub. No.: US 2026/0082176 A1
(43) Pub. Date: Mar. 19, 2026

(54) SYSTEM AND METHOD FOR CONFIRMING THE POSITION OF A COMMUNICATION DEVICE RELATIVE TO A USER'S SPECIFIC BODY PART LEVEL

(71) Applicant: Jashna Oza, San Jose, CA (US)

(72) Inventor: Jashna Oza, San Jose, CA (US)

(21) Appl. No.: 18/885,663

(22) Filed: Sep. 15, 2024

(51) Int. Cl. H04W 4/02; H04W 4/38

(52) U.S. Cl. CPC H04W 4/025; H04W 4/38

(57) ABSTRACT

The embodiments herein provide a method and a system for confirming the position of a communication device relative to a user's specific body part level. The method for confirming the position of a communication device relative to a user's specific body part level includes capturing sensor data from a plurality of sensors integrated into or connected externally to the communication device. The method further includes generating training data by prompting the user to confirm position of the communication device relative to their specific body part level and employing statistical techniques and machine learning algorithms to process the sensor data and calculate a confidence level indicating the likelihood of the communication device being at the user's specific body part level.

### FIELD

This invention relates to a method and system for confirming the position of a communication device relative to a user's specific body part level.

### BACKGROUND

A communication device is a mobile device designed mainly for communication but also equipped with advanced computing capabilities. Over the past few years, communication devices have transformed from simple communication tools into powerful devices capable of supporting a wide range of healthcare applications. Modern communication devices are equipped with a variety of sensors, such as the Global Positioning System (GPS), barometers, altimeters, gyroscopes, proximity sensors, ambient light sensors, microphones, cameras etc. Sensors detect changes in its environment and transmit the collected information to other electronic components, often a computer processor. With advancements in sensor technology, the sensors enable communication devices to gather various physiological data from the human body. This has led to the development of numerous applications aimed at monitoring and measuring health parameters such as heart rate, blood pressure, blood oxygen level, physical activity etc.

One of the main challenges with current communication device-based physiological measurements for healthcare applications is the lack of necessary calibration for communication devices. When capturing physiological data, confirming the communication device's location relative to a specific body part level is crucial. This confirmation would increase the accuracy and reliability of the data collected. However, current technology lacks methods to verify that the communication device is positioned at the correct body part level during data capture, which affects the reliability and precision of the measurements.

Proper calibration of communication devices ensures that the sensor readings are accurate and reflect the true physiological state. Further, without calibration, measurements can vary widely between different sessions, making it difficult to track health metrics reliably over time. This is particularly important for users who rely on communication devices for continuous monitoring of chronic conditions. Additionally, calibration can help minimize errors due to external factors such as movement or environmental conditions, providing more reliable data for healthcare analysis and decision-making. Despite the importance of calibration, the existing communication device-based systems lack a mechanism to confirm the precise position of the device relative to the user's body part level during measurement.

Therefore, there is a need for a unique solution that addresses the problem of lack of a mechanism to confirm the position of a communication device relative to the user's body part level at the time of data capture.

### SUMMARY

The above-mentioned shortcomings, disadvantages and problems are addressed herein, which will be understood by reading and studying the following specification.

### BRIEF DESCRIPTION OF THE FIGURES

Embodiments herein are illustrated in the accompanying drawings, throughout which like reference letters indicate corresponding parts in the various figures. The example embodiments herein will be better understood from the following description with reference to the drawings, in which:

FIG. 1 illustrates a block diagram showing different components of a system for confirming the position of a communication device relative to a user's specific body part level, in accordance with an implementation of the present invention.

FIG. 2 illustrates a block diagram showing different components of a system for confirming the position of a communication device relative to a user's specific body part level, in accordance with an embodiment of the present invention.

FIG. 3 illustrates a flowchart showing a method of confirming the position of the communication device relative to a user's specific body part level, in accordance with an implementation of the present disclosure.

### DETAILED DESCRIPTION

The embodiments herein and the various features and advantageous details thereof are explained more fully with reference to the non-limiting embodiments and detailed in the following description. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Some embodiments of this disclosure, illustrating all its features, will now be discussed in detail. The words “enabling”, “establishing”, and other forms thereof, are intended to be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof. The term “an embodiment” is to be read as “at least one embodiment.” The term “another embodiment” is to be read as “at least one other embodiment.” Although any system and methods similar or equivalent to those described herein can be used in the practice or testing of embodiments of the present disclosure, the exemplary system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The detailed description set forth below in connection with the appended drawings is intended as a description of various implementations of the present disclosure and is not intended to represent the only implementations in which details of the present disclosure may be applied. Each implementation described in this disclosure is provided merely as an example or illustration, and should not necessarily be construed as preferred or advantageous over other implementations.

There is a need for a system that addresses the problem of lack of a mechanism to confirm the position of a communication device relative to the user's specific body part level at the time of data capture.

It must be understood that reference of any specific application in current disclosure, such as the physiological parameter measurement application, is merely provided for the ease of explanation, and should not be construed as a limiting factor for application of the methodologies described herein. Therefore, it is fairly possible for a person skilled in the art to utilize the details provided in current disclosure for any similar application.

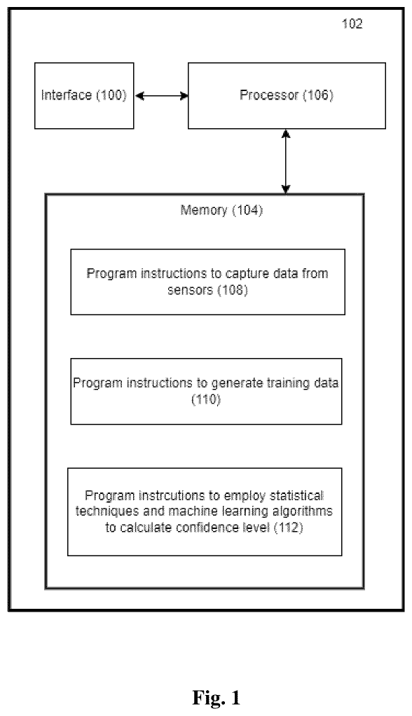

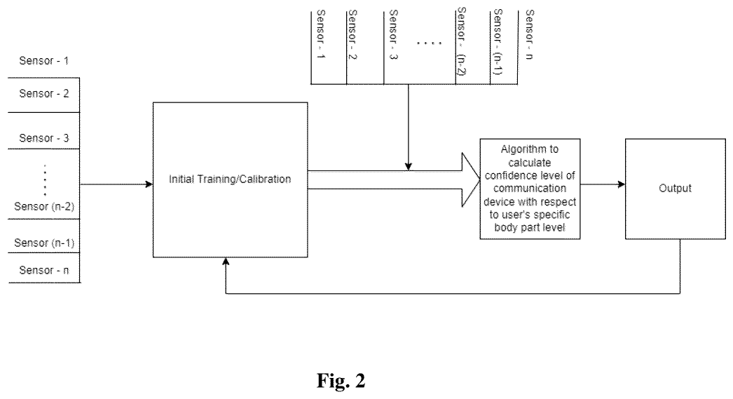

FIGS. 1 and 2 illustrate a block diagram showing different components of a system 102 for confirming the position of a communication device relative to a user's specific body part level, in accordance with an implementation of the present invention. The system 102 includes the memory 104, the processor 106, and an interface 100. The memory 104 may store program instructions to perform several functions for confirming the position of a communication device relative to a user's specific body part level. Example program instructions stored in the memory 104 may include program instructions to capture data from sensors 108, program instructions to generate training data 110, program instructions to employ statistical techniques and machine learning algorithms to calculate a confidence level 112.

The program instruction to capture sensor data may cause the processor 106 to capture sensor data from multiple sensors integrated into or connected externally to the communication device. A user may confirm the position of communication device with respect to a specific body part level of the user. The program instructions to generate training data through confirmation of the position of the communication device may cause the processor 106 to use the training data to be used initially for training an algorithm. After training, the program instructions to employ statistical techniques and machine learning algorithm may cause the processor 106 to use the sensor data for predicting a confidence level of the communication device being at the level of user's specific body part.

The communication device application may seek inputs from user to validate the predicted confidence level by asking simple question like “Is your communication device at the level of heart? (Yes/No)” and feed that information back to training data, thereby forming a highly personalized closed-loop system. The closed-loop system may be personalized to suit a specific user of the communication device. Further, the system may be designed to suit a specific model of communication device based on the available sensor types for that model. Additionally, in the event that the user elects to switch communication devices, the training data may be transferred to another communication device. Further, training of algorithm may be modified to suit the sensors in another communication device. Additionally, the algorithm may also act as-a-service for any application on the communication device by providing information on the position of the communication device relative to the user's specific body part level.

In one embodiment, the processing of the sensor data is carried out on the communication device and cloud.

In yet another embodiment, the training data can be transferred from one communication device to another communication device.

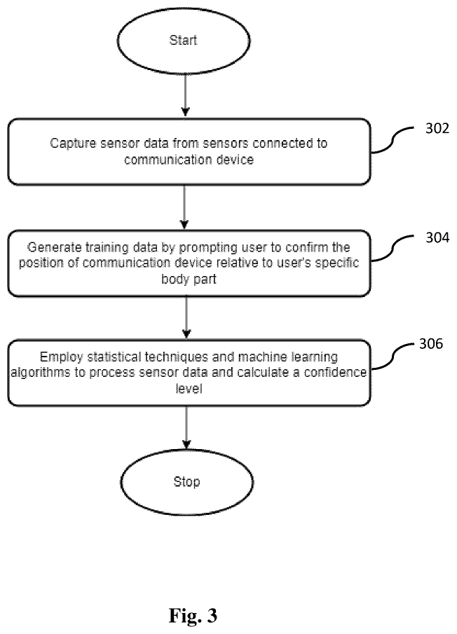

FIG. 3 illustrates a flowchart showing a method of confirming the position of the communication device relative to a user's specific body part level, in accordance with an implementation of the present disclosure. At step 302, sensor data is captured from a plurality of sensors integrated into or externally connected to the communication device. At step 304, training data is generated by prompting the user to confirm position of the communication device relative to their specific body part level. At step 306, the method further includes, employing statistical techniques and machine learning algorithms to process the sensor data and calculate a confidence level indicating the likelihood of the communication device being at the user's specific body part level.

In one embodiment, the processing of the sensor data is carried out on the communication device and cloud.

In yet another embodiment, the training data can be transferred from one communication device to another communication device.

The method is illustrated in FIG. 3 as a collection of operations in a logical flow graph representing a sequence of operations that can be implemented in hardware, software, firmware or a combination thereof.

The term “software” as used herein is intended to encompass such instructions stored in storage medium such as RAM, a hard disk, optical disk, cloud hosted, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on server or other location to perform certain functions.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

As used in the present specification, the term “artificial intelligence” refers broadly to an artificial intelligence technique in which a computer's behavior evolves based on empirical data. In some cases, input empirical data may come from databases and yield patterns or predictions thought to be features of the mechanism that generated the data. Further, a major focus of artificial intelligence is the design of algorithms that recognize complex patterns and makes intelligent decisions based on input data. Artificial Intelligence may incorporate a number of methods and techniques such as; supervised learning, unsupervised learning, reinforcement learning, multivariate analysis, case-based reasoning, backpropagation, and transduction.

An interface may be used to provide input or fetch output from the server. The interface may be implemented as a Command Line Interface (CLI), Graphical User Interface (GUI). Further, Application Programming Interfaces (APIs) may also be used for remotely interacting with the server.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARMclass processor, a microprocessor, a digital signal processor, an application specific integrated circuit, a microcontroller, a state machine, or any type of programmable logic array.

A memory may include but is not limited to, non-transitory machine-readable storage devices such as hard drives, magnetic tape, floppy diskettes, optical disks, Compact Disc Read-Only Memories (CD-ROMs), and magnetooptical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

The foregoing description of the specific embodiments will so fully reveal the general nature of the embodiments herein that others can, by applying current knowledge, readily configure and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A method for confirming the position of a communication device relative to a user's specific body part level, comprising:
capturing sensor data from a plurality of sensors integrated into or connected externally to the communication device;
generating training data by prompting the user to confirm position of the communication device relative to the user's specific body part level; and
employing statistical techniques and machine learning algorithms to process the sensor data and calculate a confidence level indicating the likelihood of the communication device being at the user's specific body part level.

2. The method of claim 1, wherein processing of the sensor data is carried out on the communication device and on cloud.

3. The method of claim 1, wherein the training data can be transferred from one communication device to another communication device.

4. A system for confirming the position of a communication device relative to a user's specific body part level, comprising:
one or more processors; and
one or more memories coupled with the one or more processors, the one or more memories storing programmed instructions, which when executed by the one or more processors, causes the one or more processors to:
capture sensor data from multiple sensors integrated into or externally connected to the communication device;
train the system by prompting the user to confirm position of the communication device relative to their specific body part level, thereby generate a training data; and
employ statistical techniques and machine learning algorithms to process the sensor data and calculate a confidence level indicating the likelihood of the communication device being at the user's specific body part level.

5. The system of claim 4, wherein processing of the sensor data is carried out on the communication device and on cloud.

6. The system of claim 4, wherein the training data can be transferred from one communication device to another communication device.
